(19) United States
(12) Patent Application Publication
(10) Pub. No.: US 2024/0369013 A1
(43) Pub. Date: Nov. 7, 2024

(54) ROTARY COMBUSTION ENGINE AND ASSOCIATED COMBUSTION METHOD

(71) Applicant: Lahcene Kerrache, St Jean de Valériscle (FR)

(72) Inventor: Lahcene Kerrache, St Jean de Valériscle (FR)

(21) Appl. No.: 18/561,159

(22) PCT Filed: Jun. 7, 2022
(86) PCT No.: PCT/IB2022/055298

§ 371 Date: Nov. 15, 2023

(30) Foreign Application Priority Data
Jun. 7, 2021 (FR) 2105973

(51) Int. Cl. F02B 55/02; F02B 53/10; F02B 55/08; F02B 55/14

(52) U.S. Cl. CPC F02B 55/02; F02B 53/10; F02B 55/08; F02B 55/14

(57) ABSTRACT

The rotary combustion engine (1) has an alternated combustion device (11) adapted (19, 20) for injecting and combusting fuel in a combustion chamber (14, 15) which is fluidically connected to an oxidant gas inlet (12) in fluidic communication with an oxidant gas intake compartment (7), and to a burnt gas outlet (13) in fluidic communication with a burnt gas exhaust compartment (8), via an alternated fluidic communication device (16, 17, 18) configured to alternately bring the combustion chamber (14, 15) into fluidic communication with the oxidant gas inlet (12) and the burnt gas outlet (13).

### TECHNICAL FIELD

The field of the invention is combustion engines.

The invention more particularly concerns a compact two-stroke combustion engine and a combustion method used by that engine.

### PRIOR ART AND DISADVANTAGES OF THE PRIOR ART

Direct or indirect injection engines with combustion chambers and pistons are well known, especially two-stroke or four-stroke petrol engines. These engines include at least one cylindrical combustion chamber in which a piston is mounted to move in translation between a position in which the volume of the chamber is minimal and a position in which the volume of the chamber is maximal.

In a two-stroke engine, following combustion of fuel in the chamber when the piston occupies the minimum volume position, the explosion initially causes movement of the piston toward its maximum volume position. Concomitantly, the burnt gases are evacuated while a mixture of fuel vapor and oxidant gas enters the chamber from outside the engine. The movement of the crankshaft then causes the piston to rise toward its minimum volume position, causing compression of the gases. A sparkplug ignites the gases as soon as the piston reaches its minimum volume position and the two-stroke cycle recommences.

In a four-stroke engine—which improves on problems with incomplete evacuation of the burnt gases from the combustion chamber observed in two-stroke engines—following combustion of fuel in the chamber while the piston is occupying the minimum volume position, the explosion initially causes movement of the piston toward its maximum volume position. The movement of the crankshaft then causes the piston to rise toward its minimum volume position and evacuation of the burnt gases from the combustion chamber. The movement of the crankshaft then causes the piston to descend toward its maximum volume position and entry into the chamber of a mixture of fuel vapor and oxidant gas. Finally, the movement of the crankshaft causes the piston to rise toward its minimum volume position, causing compression of the gases. A sparkplug ignites the gases as soon as the piston reaches its minimum volume position, and the four-stroke cycle recommences.

Although offering good performance, this four-stroke engine necessitates many components to be machined and assembled, in particular the various components enabling use of the two-stroke or four-stroke cycles. Furthermore, the combustion of fuel is not optimal, in particular because the combustion pressure is not identical from one cycle to another. An engine of this kind therefore remains a machine that is complex and costly to machine and to assemble, bulky and difficult to adjust.

### OBJECTIVE OF THE INVENTION

An object of the invention is to propose a combustion engine that is less bulky, simpler and less costly to implement and offers optimized combustion of fuel.

### STATEMENT OF INVENTION

To this end, the invention is directed to a rotary combustion engine that includes:
a frame forming a stator in which is formed a cavity extending along a longitudinal axis and having at least one first transverse dimension termed the greater width L and a second transverse dimension termed the lesser width I, which longitudinal axis is immobile relative to the frame;
a rotor including a cylindrical body extending longitudinally in the cavity and mounted to be mobile in rotation in the frame about the longitudinal axis, which cylindrical body has a diameter corresponding to the lesser width of the cavity and defines two opposite zones flush with the surface of the cavity forming a bottleneck that separates the cavity in sealed manner into an oxidant gas intake compartment and a burnt gas exhaust compartment, each of the intake and exhaust compartments being delimited by said external face of the cylindrical body and said surface of the cavity and being respectively in fluidic communication with an oxidant gas intake inlet and a burnt gas exhaust outlet formed in the wall of said frame;
said rotor including at least one member for driving the gases contained in the compartments mounted in a longitudinal opening formed in the cylindrical body of the rotor and configured to be driven in rotation by said cylindrical body about the longitudinal axis;
said engine including means whereby the free ends of the drive members are flush with the internal face of the cavity by sliding of said drive members in the opening in a direction perpendicular to the longitudinal axis between a minimal position in which its free end is flush with the internal face of the cavity at the level of its lesser width I and a maximal position in which its free end is flush with the internal face of the cavity at the level of its greater width L; and
an alternated combustion device including means for injecting fuel into a combustion chamber and combusting it therein fluidically connected to an oxidant gas inlet in fluidic communication with the intake compartment and to a burnt gas outlet in fluidic communication with the exhaust compartment via an alternated fluidic communication device configured to place the combustion chamber alternately in fluidic communication with the oxidant gas inlet and the burnt gas outlet.

The engine may also have the following optional features separately or in all technically possible combinations:
The engine includes diametrically opposite first and second members for driving the gases contained in the compartments and two combustion chambers, the alternated communication device includes an alternated intake device configured to place one of the two combustion chambers alternately in fluidic communication with the oxidant gas inlet and an alternated exhaust device configured to place one of the two combustion chambers alternately in fluidic communication with the burnt gas outlet.
The means whereby the free ends of the drive members are flush with the internal face of the cavity include a perimeter rail secured to the frame and formed in the cavity, which rail is adapted to guide the sliding of the drive members in the openings concerned during their rotation about the longitudinal axis.
The perimeter rail includes two rail portions connected to each other to pivot by two respective ends of said two rail portions, the opposite ends of the two rail portions including respective sliding members of complementary shape cooperating with each other to assure the continuity of the perimeter rail.
Each drive member includes a guide shaft projecting from a free end part of said drive member, which shaft is adapted to cooperate with a groove formed in the perimeter rail.
The engine includes a housing the wall of which delimits part of the cavity, which housing includes an end mounted to pivot on the frame about an axis parallel to the longitudinal axis and is mobile between a position minimizing the volume of the intake compartment and a position maximizing the volume of said intake compartment.
The engine includes means for actuating the pivoting of the housing driven by the management system of the engine.
The alternated combustion device includes means for varying the volume of each combustion chamber.
The intake and exhaust devices respectively formed at the inlet and at the outlet of the combustion chambers are valves controlled by the management system of the engine.
Each combustion chamber includes a check valve formed at the inlet of the combustion chamber concerned.
The intake and exhaust compartments take the form of respective crescents disposed on respective opposite sides of the bottleneck.

The invention is also directed to a method of combustion in a rotary combustion engine as described above, the rotor rotating about its longitudinal axis and each drive member defining in the intake compartment a compression sub-compartment fluidically connected to the oxidant gas inlet of the alternated combustion device and an intake sub-compartment fluidically connected to the oxidant gas intake inlet of the frame and in the exhaust compartment an expansion sub-compartment fluidically connected to the burnt gas exhaust outlet of the alternated combustion device and an exhaust sub-compartment fluidically connected to the exhaust outlet, which method includes the following successive steps:
the inlets of the first and second combustion chambers being respectively open and closed, the outlets of said first and second chambers being respectively closed and open, the first drive member in motion in the intake compartment and the second drive member in motion in the exhaust compartment drive intake of oxidant gases into the intake sub-compartment, compression of oxidant gases in the compression sub-compartment, intake of compressed gas into the first combustion chamber, ejection of burnt gas from the second intake chamber into the expansion sub-compartment, and exhausting from the cavity of the burnt gases contained in the exhaust sub-compartment;
as soon as the free ends of the two drive members have passed the bottleneck, a management system of the engine closes the inlet of the first chamber and the outlet of the second chamber and opens the inlet of the second chamber and the outlet of the first chamber;
actuation of the injection and combustion means of the first chamber to inject fuel into said chamber followed by combustion of the mixture of fuel and oxidant gases present in the first chamber;
driving the first drive member in the exhaust compartment and the second drive member in the intake compartment by the pressure generated by the explosion in the first chamber, causing ejection of burnt gases from the first intake chamber into the expansion sub-compartment, exhausting from the frame of the burnt gases contained in the exhaust sub-compartment, intake of oxidant gases into the intake sub-compartment, compression of oxidant gases in the compression sub-compartment, and intake of compressed gases into the second combustion chamber;
as soon as the free ends of the two drive members have passed the bottleneck, the management system of the engine closes the inlet of the second chamber and the outlet of the first chamber and opens the inlet of the first chamber and the outlet of the second chamber;
actuation of the injection and combustion means of the second chamber to inject fuel into said chamber followed by combustion of the mixture of fuel and oxidant gases present in the second chamber; and
repetition of the preceding steps for as long as the engine is actuated.

### DESCRIPTION OF THE FIGURES

Other features and advantages of the invention will emerge clearly from the description thereof given hereinafter by way of non-limiting illustration with reference to the appended figures:

FIG. 1 represents a view in cross section of the engine of the invention on a first plane;

FIG. 2 represents a view in cross section of the engine of the invention on a second plane II-II in FIG. 3;

FIG. 3 represents a view in longitudinal section of the engine of the invention on the plane III-III in FIG. 2;

FIG. 4 represents a view in cross section of the engine of the invention on the plane IV-IV in FIG. 5;

FIG. 5 represents a view in longitudinal section of the engine of the invention on the plane V-V in FIG. 4;

FIG. 6 represents a view of the alternated combustion device in longitudinal section on the plane VI-VI in FIG. 1;

FIG. 7a

FIG. 7b

FIGS. 7a to 7c represent a kinematic of the operation of the engine by means of views in cross-section of the engine of the invention on the first plane.

### DETAILED DESCRIPTION OF THE INVENTION

It is first specified that in the figures the same references designate the same elements whichever figure they appear in and whatever the manner of representing those elements. Likewise, if elements are not specifically referenced in one of the figures, their references may easily be found by referring to another figure.

It is also specified that the figures essentially represent one embodiment of the object of the invention but other embodiments may exist that conform to the definition of the invention.

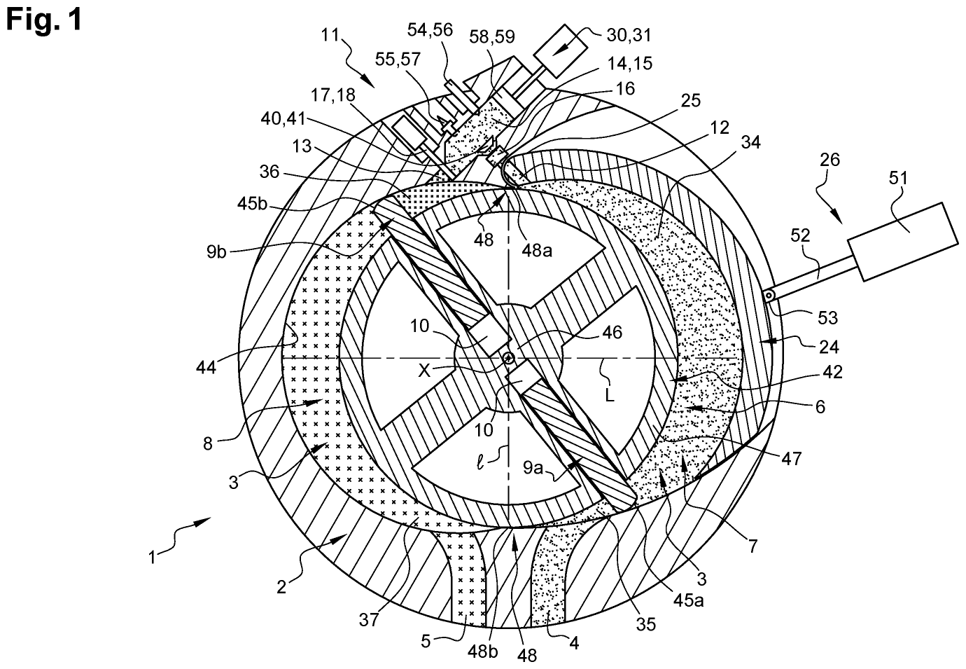

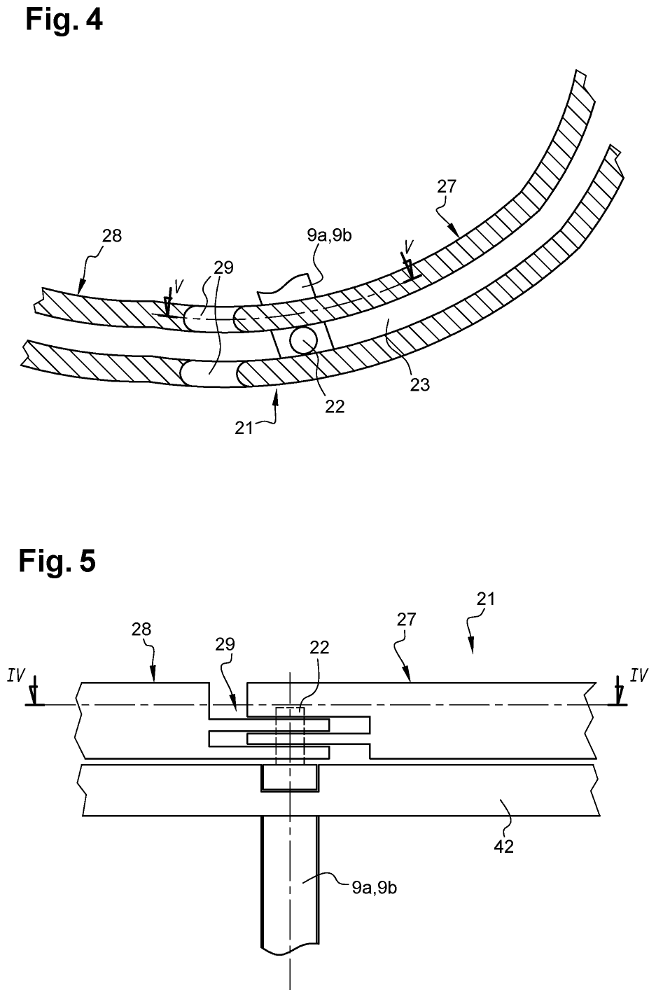

The combustion engine according to the invention is described next with reference to FIGS. 1 to 6.

Referring to FIG. 1, the engine 1 includes a frame 2 preferably made of metal. This frame 2 forms the stator of the engine 1 and includes a longitudinal cavity 3 that extends along a longitudinal axis X, which longitudinal axis X is immobile relative to the frame 2. Although the frame 2 has a globally cylindrical external surface, its surface that delimits the cavity 3 has a globally elliptical shape with two transverse dimensions I, L, respectively a minimum dimension I and a maximum dimension L. The maximum transverse dimension L is referred to in the remainder of the description as the greater width L while the minimum transverse dimension I is referred to as the lesser width. Moreover, the surface delimiting the cavity 3 is covered by a flexible sealing material (not represented) the function of which is described below.

The cavity 3 is advantageously formed by two longitudinal cylindrical openings that are not coaxial and have the same diameter, the distance between the two respective axes of the cylindrical openings being less than the diameter of each cylindrical opening.

The engine 1 also includes a rotor 6 disposed in the cavity 3 and extending longitudinally therein. The rotor 6 includes a cylindrical body 42 including a central shaft 46 mounted to rotate in the frame 2 about the longitudinal axis X and a perimeter wall 47 secured to the central shaft 46 and the diameter of which at the level of its external surface assures that it is a close fit in the frame 2 at the level of the lesser width of the cavity 3. The close fit of the rotor 6 in the cavity 3 therefore forms two diametrically opposite flush zones 48a, 48b that define a bottleneck 48 at the level of the lesser width I of the cavity 3 between the surface 44 of said cavity 3 (that is to say the internal surface 44 of the frame 2) and the external face of the perimeter wall 47 of the cylindrical body 42 of the rotor 6. These flush zones 48a, 48b are also covered with a flexible sealing material (not represented). The two flush zones 48a, 48b and the center of the cylindrical body 42 passing through the longitudinal axis X are therefore aligned with the result that the cylindrical body 42 is a close fit in the frame 2 at the level of the lesser width I of the cavity 3.

Thus, while remaining free to rotate about the axis X, the cylindrical body 42 separates the cavity 3 into two compartments 7, 8 disposed on respective opposite sides of the bottleneck 48, respectively an oxidant gas intake compartment 7 and a burnt gas exhaust compartment 8, as explained below. These two compartments 7, 8 are delimited by the external face of the cylindrical body 42 and by part of the internal surface 44 of the frame 2 and each is crescent shaped. Furthermore, these two compartments 7, 8 are separated in sealed manner by the flush zones 48a, 48b covered with the flexible sealing material. In other words, the intake compartment 7 and the exhaust compartment 8 are not in fluidic communication with each other and so the oxidant gases and the burnt gases are never mixed in the cavity 3.

The engine 1 further includes an inlet 4 for an oxidant gas, typically ambient air external to the frame 2, and an outlet 5 for burnt gases, termed exhaust gases, external to the frame 2. The oxidant gas inlet 4 and the burnt gas outlet 5 are formed in the wall of the frame 2 and are respectively in fluidic communication with the intake compartment 7 and the exhaust compartment 8. Thus, the inlet and outlet 4, 5 are disposed on respective opposite sides of the bottleneck 48 and are therefore independent.

The rotor 6 further includes at least one drive member for driving the gases contained in the intake compartment 7 and the exhaust compartment 8, and preferably two diametrically opposite drive members 9a, 9b. These drive members 9a, 9b are therefore driven in rotation about the axis X at the same time as the cylindrical body 42 of the rotor 6. In the remainder of the description, each drive member 9a, 9b is referred to as a vane. The vanes 9a, 9b are housed in two openings 10 in the perimeter wall 47 of the cylindrical body 42 of the rotor 6 on respective opposite sides of the longitudinal axis X.

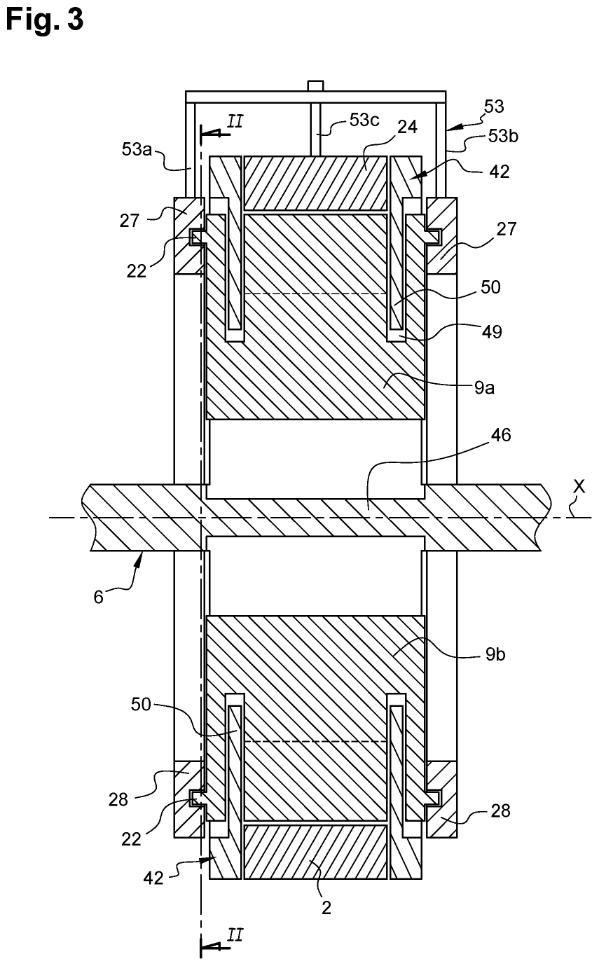

Referring to FIG. 3, each vane 9a, 9b takes the form of a rectangular block that extends along the longitudinal axis X and has an end facing the shaft 46 of the cylindrical body 42 and an opposite free end 45a, 45b facing the internal surface 44 of the frame 2. Furthermore, each vane 9a, 9b includes two transverse grooves 49 discharging at the level of the free end 45a, 45b, each groove 49 cooperating with a tenon 50 secured to the cylindrical body 42 of the rotor 6 and extending transversely in the groove 49 concerned: each vane 9a, 9b is therefore mounted to slide transversely (perpendicularly to the longitudinal axis X) in the opening 10 concerned. Furthermore, the surface of the groove 49 and the surfaces of the tenons 50 are also covered with a sealing material (not represented) as described above to assure sealed contact between each tenon 50 and the vane 9a, 9b concerned.

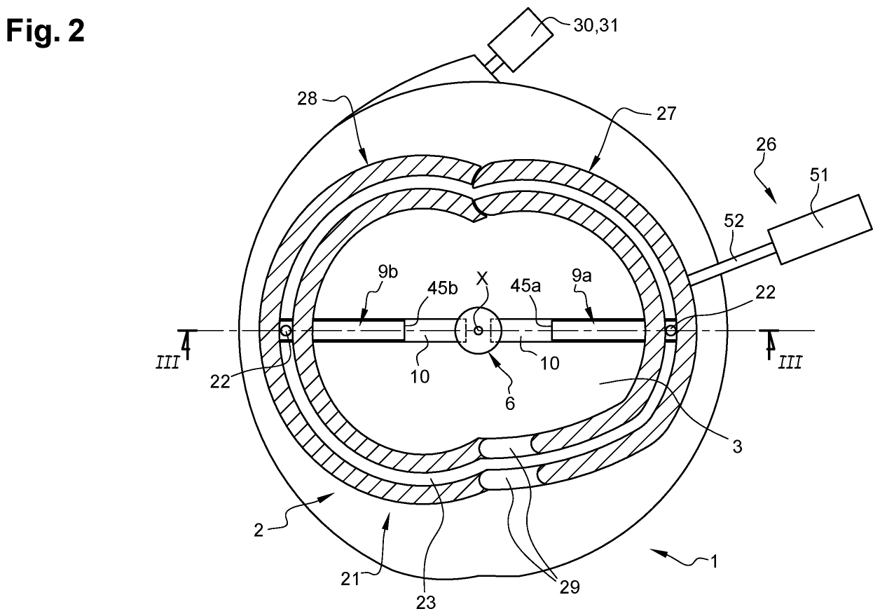

Referring to FIGS. 2 and 3, the engine 1 also includes means whereby the free ends 45a, 45b of the vanes 9a, 9b are flush with the surface 44 of the cavity 3 by virtue of said vanes 9a, 9b sliding in the openings 10 concerned. These means include two perimeter rails 21 secured to the frame 2 and arranged in the cavity 3. These two rails 21 extend in two parallel planes perpendicular to the longitudinal axis X and are disposed on respective opposite sides of the vanes 9a, 9b. Furthermore, each rail 21 includes a central perimeter groove 23, said grooves 23 of the respective rails 21 being disposed face-to-face.

The means whereby the free ends of the vanes are flush with the surface of the cavity also include guide shafts 22 projecting from the walls of the vanes 9a, 9b along the longitudinal axis X. Each vane 9a, 9b includes two opposite guide shafts 22 each extending in the direction of the rail 21 concerned so as to be accommodated in the groove 23 concerned. The guide shafts 22 of each vane 9a, 9b cooperating with the two opposite grooves 23 of the two rails 21, the free ends 45a, 45b of the vanes 9a, 9b are a close fit in the frame 2 flush with the internal surface 44 of the frame 2. In particular, the free ends 45a, 45b of the vanes 9a, 9b include a sealing segment (not represented) made of a flexible material that comes into sealed contact with the sealing material covering the internal surface of the frame 2, including at the level of the flush zones 48a, 48b.

As a result, when the rotor 6 rotates about the axis X, the guide shafts 22 of the vanes 9a, 9b are moved along the grooves 23 of the rails 21 concerned, causing each vane 9a, 9b to move by sliding in its opening 10 between a minimal position in which the respective free ends 45a, 45b of the two vanes 9a, 9b are flush with the internal surface 44 of the frame 2 at the level of the lesser width I of the cavity 3, that is to say at the level of the two flush zones 48a, 48b, and a maximal position in which the respective free ends 45a, 45b of the two vanes 9a, 9b are flush with the internal surface 44 of the frame 2 at the level of the greater width L of the cavity 3. Of course, the free ends 45a, 45b of the vanes 9a, 9b are still a close fit in the frame 2, i.e. the sealing segments formed at the level of the free ends 45a, 45b of the vanes 9a, 9b are still in contact with the internal surface of the frame 2, regardless of the position of the rotor 6 and the position of the free ends 45a, 45b of the vanes 9a, 9b in the cavity 3.

Moreover, still referring to FIG. 3, the cylindrical body 42 of the rotor 6 is hollow and has in axial section an H shape. There therefore exists a small area of contact between the walls of the vanes 9a, 9b and the walls of the cylindrical body 42, which contributes to reducing the friction between said vanes 9a, 9b and the walls of the cylindrical body 42 when the vanes 9a, 9b move in the corresponding openings 10 of the cylindrical body 42.

When the vanes 9a, 9b are in intermediate sliding positions between their maximal and minimal positions, they respectively separate the admission compartment 7 into an intake sub-compartment 35 and a compression sub-compartment 34 and the exhaust compartment 8 into an expansion sub-compartment 36 and an exhaust sub-compartment 37. The intake sub-compartment 35 and the compression sub-compartment 34, on the one hand, and the expansion sub-compartment 36 and the exhaust sub-compartment 37, on the other hand, are separated in sealed manner by the sealing segments formed at the free ends 45a, 45b of the vanes 9a, 9b and on the internal surface of the frame 2 delimiting the cavity 3. The function of these sub-compartments 34-37 is described below in connection with a method of combustion in the engine 1 of the invention.

The frame 2 further includes a mobile housing 24 the wall of which delimits part of the cavity 3 and in particular delimits part of the intake compartment 7. This housing 24 has in section perpendicular to the longitudinal axis X an arcuate shape and is mounted at one of its ends 25 to pivot on the frame 2 about an axis parallel to the longitudinal axis X. The pivoting movement of the housing 24 about its axis is driven by a drive device 26, in particular an actuator controlled by a management system of the engine, between a minimal position minimizing the volume of the intake compartment 7 and a maximal position maximizing the volume of the intake compartment 7. The driven movement of the housing 24 therefore makes it possible to vary the cubic capacity of the engine 1 by varying the volume of oxidant gas that can be admitted into the intake chamber 7.

Moreover, and referring to FIG. 2, each rail 21 includes two rail portions 27, 28 connected to each other to pivot about an axis parallel to the longitudinal axis X by respective ends of said rail portions 27, 28. For each rail 21, one portion 28 is immobile while the adjacent other portion 27 is mobile, pivoting about its axis between a minimal position minimizing the perimeter of the rail 21 concerned and a maximal position maximizing the perimeter of the rail 21 concerned. The respective pivoting portions 27 of the rails 21 are moreover disposed face-to-face. Furthermore, the two facing rail portions 27 pivot at the same time as the housing 24, driven by the same controlled actuator 26.

Referring to FIGS. 2, 4 and 5, the opposite ends of the rail portions 27, 28 include sliding members 29 cooperating with and interlocked with each other to assure the continuity of each rail 21 whatever the position of the pivoting rail portions 27.

Referring to FIGS. 1 and 3, the controlled actuator 26 includes a piston 51 with a piston rod 52 the end of which is secured to the base of a fork 53, which fork 53 comprises three arms 53a, 53b, 53c the free ends of which are respectively secured to the two pivoting rail portions 27 and the external face of the housing 24.

The movement in translation of the piston rod 52 of the piston 51 therefore causes the housing 24 to pivot and the variation of the volume of the intake compartment 7 and the variation of the perimeter of the rails 21. In this way the free ends 45a, 45b of the vanes 9a, 9b remain a close fit to the internal surface 44 of the frame 2 whatever the position of the mobile housing 24.

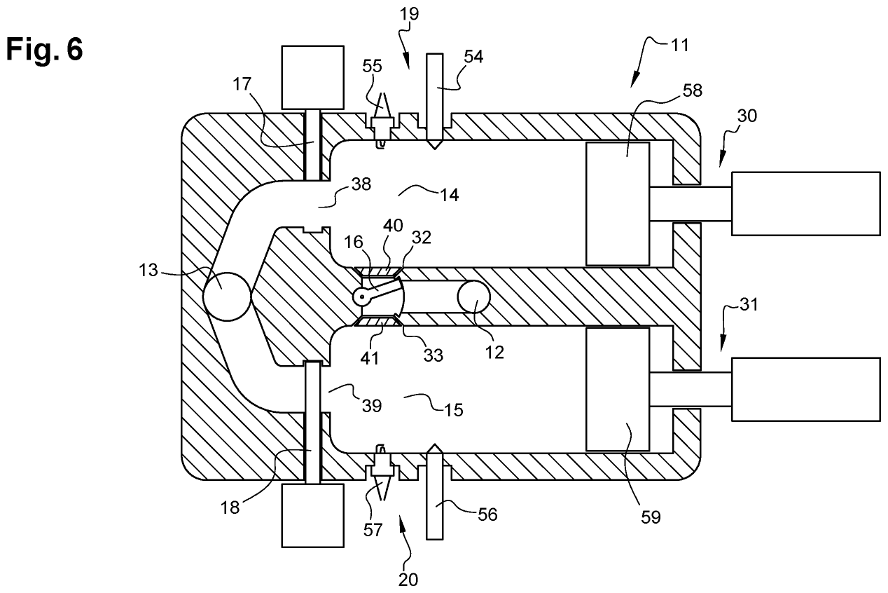

Referring to FIGS. 1 and 6, the engine 1 includes an alternated combustion device 11 including an oxidant gas inlet 12 formed in the housing 24 and in fluidic communication with the intake compartment 7 and a burnt gas outlet 13 formed in the frame and in fluidic communication with the exhaust compartment 8.

The alternated combustion device 11 further includes two combustion chambers 14, 15 referred to hereinafter as the first chamber 14 and the second chamber 15.

Each chamber 14, 15 includes an oxidant gas inlet 32, 33 fluidically connected to the oxidant gas inlet 12 of the alternated combustion device 11. The inlets 32, 33 of the chambers 14, 15 further include a check valve 40, 41 preventing the gas contained in the chamber 14, 15 concerned from escaping to the intake compartment 7. Each chamber 14, 15 further includes a burnt gas outlet 38, 39 in fluidic communication with the burnt gas outlet 13 of the alternated combustion device 11.

In the remainder of the description, the inlet 32 and the outlet 38 of the first chamber 14 are referred to as the first inlet 32 and the first outlet 38 and the inlet 33 and the outlet 39 of the second chamber 15 are referred to as the second inlet 33 and the second outlet 39.

The alternated combustion device 11 also includes a device for alternated intake of oxidant gases into the combustion chambers 14, 15 driven by the management system of the engine. This device includes a valve 16 mobile between a first position in which it blocks the second inlet 33 of the second chamber 15 and frees the first inlet 32 of the first chamber 14 that is then in fluidic communication with the intake compartment 7 and a second position (represented in FIG. 6) in which it blocks the first inlet 32 of the first chamber 14 and frees the second inlet 33 of the second chamber 15 that is then in fluidic communication with the intake compartment 7.

The alternated combustion device 11 further includes a device for alternated exhausting of burnt gases from the combustion chambers 14, 15 that is driven by the management system of the engine 1. This device includes two guillotine valves 17, 18 driven by the management system, respectively installed at the level of the first and second burnt gas outlets 38, 39 of the combustion chambers 14, 15. In the remainder of the description, the guillotine valve 17 installed at the outlet of the first chamber 14 is termed the first valve 17 and the guillotine valve 18 installed at the outlet of the second chamber 15 is termed the second valve 18.

This alternated exhaust device can be actuated between a first position in which the first valve 17 is closed and blocks the first outlet 38 of the first chamber 14 and the second valve 18 is open and enables fluidic communication between the second chamber 15 and the exhaust compartment 8 and a second position (represented in FIG. 6) in which the second valve 18 is closed and blocks the second outlet 39 of the second chamber 15 and the first valve 17 is open and enables fluidic communication between the first chamber 14 and the exhaust compartment 8.

The alternated intake device and the alternated exhaust device form an alternated fluidic communication device 16, 17, 18 that is driven by the management system between a first position in which the alternated intake and exhaust devices are in the first position and a second position in which the alternated intake and exhaust devices are in the second position.

The alternated combustion device 16, 17, 18 also includes first means 19 for injecting fuel into the first combustion chamber 14 and combusting it therein and second means 20 for injecting fuel into the second combustion chamber 15 and combusting it therein.

To be more precise, the first injecting and combusting means 19 include a first fuel injection nozzle 54 fluidically connected to a fuel tank (not represented) and discharging into the first combustion chamber 14 and a first fuel ignition member 55, for example a sparkplug, for igniting the fuel in the first chamber 14. The second injecting and combusting means 20 include a second fuel injection nozzle 56 fluidically connected to the fuel tank and discharging into the second combustion chamber 15 and a second fuel ignition member 57, for example a sparkplug, for igniting the fuel in the second chamber 15. The nozzles 54, 56 are configured to inject the fuel in nebulized form.

Finally, the alternated combustion device 16-18 includes means 30, 31 for varying the volume of each combustion chamber 14, 15.

These variation means include first and second actuators 30, 31 controlled by the management system, which actuators 30, 31 respectively include a first piston 58 which is a close fit in the first chamber 14 and a second piston 59 which is a close fit in the second chamber 15. These pistons 58, 59 are mobile in translation in the chambers 14, 15 concerned and therefore make it possible to vary the inherent volume of each chamber 14, 15. The volume variation means 30, 31 thus make it possible to vary as required the cubic capacity of the alternated combustion device 11.

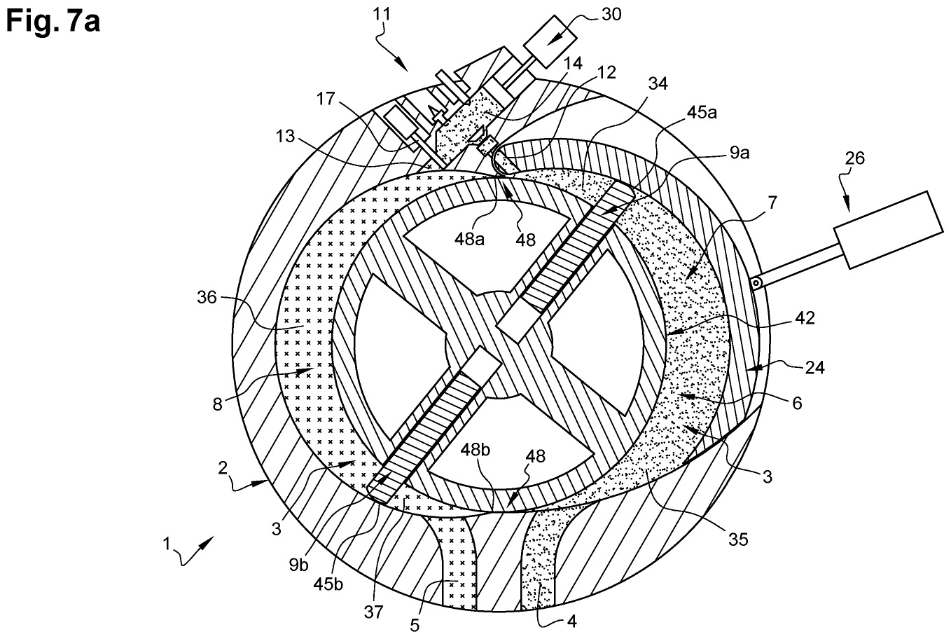

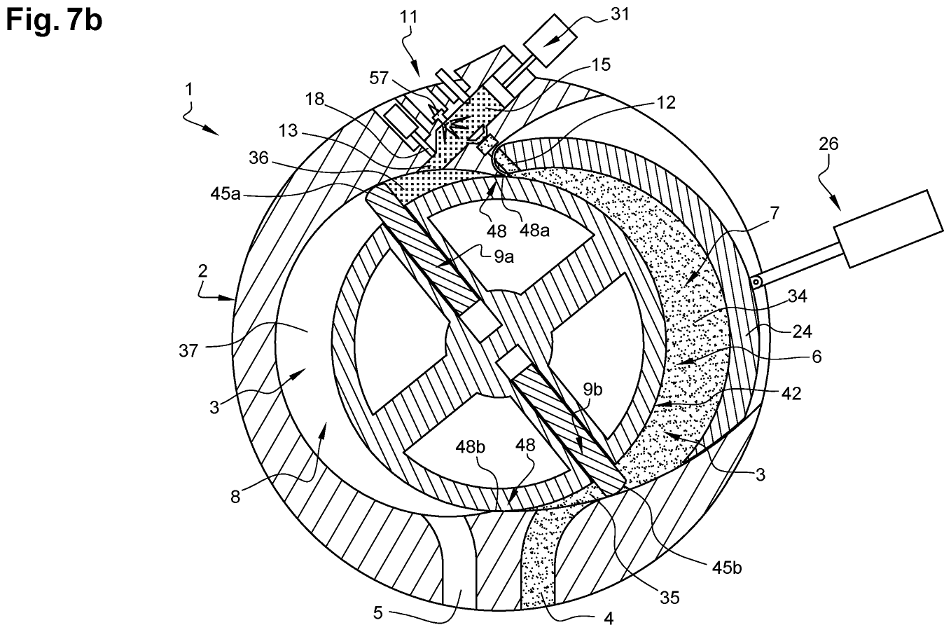

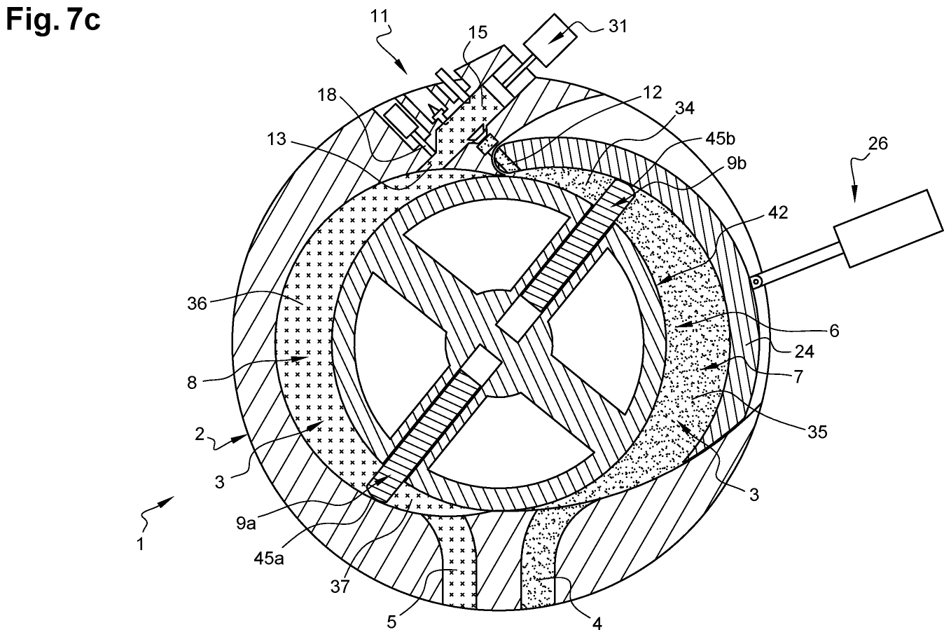

A combustion process of the engine 1 of the invention is described next with reference to FIG. 1 and FIGS. 7a to 7c.

An initial situation is considered in which the first and second vanes 9a, 9b are as represented in FIG. 1 and the fluidic communication device 16-18 is in the first position, that is to say:
the first inlet 32 of the first chamber 14 is open,
the second inlet 33 of the second chamber 15 is closed,
the first outlet 38 of the first chamber 14 is closed, and
the second outlet 39 of the second chamber 15 is open.

It is also considered that the rotor 6 is moving because of initial combustion of fuel injected beforehand into the second chamber 15, for example after the ignition of the engine 1 is turned on.

The pressure generated by the combustion of fuel in the second chamber 15 causes the expulsion of burnt gases via the outlet 39 of this second chamber 15 into the expansion sub-compartment 36. The increase in the gas pressure in the expansion sub-compartment 36 drives the second vane 9b in the anticlockwise direction. The movement of the second vane 9b then causes an increase in the volume of the expansion sub-compartment 36 and a reduction of the volume of the exhaust sub-compartment 37, which is reflected in the progressive exhausting of burnt gases via the exhaust outlet 5 of the engine 1.

The rotation of the first vane 9a then causes an increase in the volume of the intake sub-compartment 35 and a reduction of the volume of the compression sub-compartment 34, which is reflected in the progressive intake of oxidant gas via the intake inlet 4 of the engine 1 and by intake of oxidant gas into the first chamber 14. The vanes 9a, 9b are then in the position represented in FIG. 7a.

As soon as the free ends 45a, 45b of the vanes 9a, 9b pass the bottleneck 48, the management system drives the alternated fluidic communication device 16-18 from the first position to the second position, that is to say:
the first inlet 32 of the first chamber 14 is closed,
the second inlet 33 of the second chamber 15 is open,
the first outlet 38 of the first chamber 14 is open, and
the second outlet 39 of the second chamber 15 is closed.

As soon as the first vane 9a passes the exhaust outlet of the alternated combustion device 11, as represented in FIG. 7b, the management system drives the injection of fuel into the first chamber 14 followed by ignition of the fuel and oxidant gas mixture to generate the combustion of the fuel in said chamber 14.

The pressure generated by the combustion of fuel in the first chamber 14 causes expulsion of burnt gases via the outlet 38 of this first chamber 14 into the expansion sub-compartment 36. The increase of the gas pressure in the expansion sub-compartment 36 drives the first vane 9a in the counterclockwise direction. The movement of the first vane 9a then causes an increase in the volume of the expansion sub-compartment 36 and a reduction of the volume of the exhaust sub-compartment 37, which is reflected in the progressive exhausting of burnt gases via the exhaust outlet 5 of the engine 1.

The rotation of the second vane 9b then causes an increase in the volume of the intake sub-compartment 35 and a reduction of the volume of the compression sub-compartment 34, which is reflected in the progressive intake of oxidant gas via the intake inlet 4 of the engine 1 and intake of oxidant gas into the second chamber 15. The vanes 9a, 9b are then in the position represented in FIG. 7c.

As soon as the free ends 45a, 45b of the vanes 9a, 9b pass the bottleneck 48, the management system drives the alternated fluidic communication device 16-18 from the second position to the first position and the combustion cycle recommences.

The engine 1 of the invention enables separation of the combustion chambers 14, 15 from the gas compression sub-compartment 34 and the gas expansion sub-compartment 36. This enables constant gas compression and optimum fuel combustion since the latter burns in an atmosphere free of burnt gases. On the other hand, this engine 1 does not necessitate a housing or connecting rod, since the expansion and compression of the gases are effected by the rotor 6 and more precisely by the vanes 9a, 9b driven in rotation by the cylindrical body 42. The construction of the engine 1 is therefore simplified and the engine 1 is relatively compact for a delivered power equivalent to classic four-stroke engines of the same cubic capacity, which makes it an ideal engine 1 for a hybrid vehicle. Finally, this engine 1 offers the possibility of varying its cubic capacity, which enables the user to adapt the power demand as a function of the situation encountered.

The present invention is in no way limited to this configuration and may incorporate structural variations without departing from the scope of the invention. For example, the rotor 6 may include only one vane and the alternated combustion device may include only one combustion chamber. In this case, the alternated fluidic communication device can be actuated by the management system between a first position in which the inlet and the outlet of the combustion chamber are respectively open and closed and a second position in which the inlet and the outlet of the combustion chamber are respectively closed and open.

In this case, the combustion process is simplified.

The fluidic communication device being in its first position, the vane is moving in the intake compartment 7 to enable intake of oxidant gas on the one hand and entry of oxidant gas into and compression thereof in the chamber on the other hand. Once the vane passes the flush zone 48a, the fluidic communication device goes to the second position, which closes the inlet and opens the outlet of the combustion chamber. Once the vane passes the outlet of the chamber, injection of fuel into and compression thereof in the combustion chamber are commanded, which causes the vane to move into the exhaust compartment 8 and the expansion of the burnt gases on the one hand and the exhausting of the burnt gases from the frame 2 on the other hand. As soon as the vane has performed a half-turn and passes the opposite flush zone 48b, the fluidic communication device goes to the first position and the cycle recommences.

1. A rotary combustion engine including:
a frame forming a stator in which is formed a cavity extending along a longitudinal axis and having at least one first transverse dimension termed greater width and a second transverse dimension termed lesser width, the longitudinal axis being immobile relative to the frame,
a rotor including a cylindrical body extending longitudinally in the cavity and mounted to be mobile in rotation in the frame about the longitudinal axis, the cylindrical body having a diameter corresponding to the lesser width of the cavity and defining two opposite zones flush with a surface of the cavity forming a bottleneck that separates the cavity in a sealed manner into an oxidant gas intake compartment and a burnt gas exhaust compartment, each of the intake and exhaust compartments being delimited by an external face of the cylindrical body and the surface of the cavity and being respectively in fluidic communication with an oxidant gas intake inlet and a burnt gas exhaust outlet formed in a wall of the frame,
the rotor including at least one member for driving gases contained in the compartments mounted in a longitudinal opening formed in the cylindrical body of the rotor and configured to be driven in rotation by the cylindrical body about the longitudinal axis,
the engine including means whereby the free ends of the drive members are flush with an internal face of the cavity by sliding of the drive members in the opening in a direction perpendicular to the longitudinal axis between a minimal position in which the respective free end is flush with the internal face of the cavity at the lesser width and a maximal position in which the respective free end is flush with the internal face of the cavity at the greater width, and
the alternated combustion device including means for injecting fuel into a combustion chamber and combusting the fuel therein fluidically connected to an oxidant gas inlet in fluidic communication with the intake compartment and to a burnt gas outlet in fluidic communication with the exhaust compartment via an alternated fluidic communication device configured to place the combustion chamber alternately in fluidic communication with the oxidant gas inlet and the burnt gas outlet.

2. The engine as claimed in claim 1, including diametrically opposite first and second members for driving the gases contained in the compartments and two combustion chambers, and wherein the alternated communication device includes an alternated intake device configured to place one of the two combustion chambers alternately in fluidic communication with the oxidant gas inlet and an alternated exhaust device configured to place one of the two combustion chambers alternately in fluidic communication with the burnt gas outlet.

3. The engine as claimed in claim 1, wherein the means whereby the free ends of the drive members are flush with the internal face of the cavity include a perimeter rail secured to the frame and formed in the cavity, the rail being adapted to guide sliding of the drive members in the respective openings during rotation of the drive members about the longitudinal axis.

4. The engine as claimed in claim 3, wherein the perimeter rail includes two rail portions connected to each other to pivot by two respective ends of the two rail portions, opposite ends of the two rail portions including respective sliding members of complementary shape cooperating with each other to assure the continuity of the perimeter rail.

5. The engine as claimed in claim 3, wherein each drive member includes a guide shaft projecting from a free end part of the drive member, the shaft is being adapted to cooperate with a groove formed in the perimeter rail.

6. The engine as claimed in claim 1, including a housing having a wall which delimits part of the cavity, the housing including an end mounted to pivot on the frame about an axis parallel to the longitudinal axis and being mobile between a position minimizing a volume of the intake compartment and a position maximizing the volume of the intake compartment.

7. The engine as claimed claim 6, including means for actuating pivoting of the housing driven by a management system of the engine.

8. The engine as claimed in claim 1, wherein the alternated combustion device includes means for varying a volume of the combustion chamber.

9. The engine as claimed in claim 2, wherein the intake and exhaust devices respectively formed at the inlet and at the outlet of the combustion chambers are valves controlled by a management system of the engine.

10. The engine as claimed in claim 1, wherein the combustion chamber includes a check valve formed at an inlet of the combustion chamber.

11. A method of combustion in a rotary combustion engine as claimed in claim 2, the rotor rotating about the longitudinal axis and each drive member defining in the intake compartment a compression sub-compartment fluidically connected to the oxidant gas inlet of the alternated combustion device and an intake sub-compartment fluidically connected to the oxidant gas intake inlet of the frame and in the exhaust compartment an expansion sub-compartment fluidically connected to the burnt gas exhaust outlet of the alternated combustion device and an exhaust sub-compartment fluidically connected to the exhaust outlet, the method comprising the following successive actions:
the inlets of the first and second combustion chambers being respectively open and closed, the outlets of the first and second chambers being respectively closed and open, the first drive member in motion in the intake compartment and the second drive member in motion in the exhaust compartment, driving intake of oxidant gases into the intake sub-compartment, compression of oxidant gases in the compression sub-compartment, intake of compressed gas into the first combustion chamber, ejection of burnt gas from the second intake chamber into the expansion sub-compartment, and exhausting from the cavity of the burnt gases contained in the exhaust sub-compartment;
as soon as the free ends of the two drive members have passed the bottleneck, by an engine management system of the engine, closing the inlet of the first chamber and the outlet of the second chamber and opening the inlet of the second chamber and the outlet of the first chamber;
actuating the injection and combustion means to inject fuel into the chamber followed by combustion of the mixture of fuel and oxidant gases present in the first chamber;
driving the first drive member in the exhaust compartment and the second drive member in the intake compartment by pressure generated by explosion in the first chamber, causing ejection of burnt gases from the first intake chamber into the expansion sub-compartment, exhausting from the frame of burnt gases contained in the exhaust sub-compartment, intake of oxidant gases into the intake sub-compartment, compression of oxidant gases in the compression sub-compartment, and intake of compressed gases into the second combustion chamber;
as soon as the free ends of the two drive members have passed the bottleneck, by the management system of the engine, closing the inlet of the second chamber and the outlet of the first chamber and opening the inlet of the first chamber and the outlet of the second chamber;
actuating the injection and combustion means of the second chamber to inject fuel into the chamber followed by combustion of a mixture of fuel and oxidant gases present in the second chamber; and
repeating the preceding actions for a duration of actuation of the engine.

12. The engine as claimed in claim 2, wherein the means whereby the free ends of the drive members are flush with the internal face of the cavity include a perimeter rail secured to the frame and formed in the cavity, the rail being adapted to guide sliding of the drive members in the respective openings during rotation of the drive members about the longitudinal axis.

13. The engine as claimed in claim 12, wherein the perimeter rail includes two rail portions connected to each other to pivot by two respective ends of the two rail portions, opposite ends of the two rail portions including respective sliding members of complementary shape cooperating with each other to assure the continuity of the perimeter rail.

14. The engine as claimed in claim 4, wherein each drive member includes a guide shaft projecting from a free end part of the drive member, the shaft being adapted to cooperate with a groove formed in the perimeter rail.

15. The engine as claimed in claim 12, wherein each drive member includes a guide shaft projecting from a free end part of the drive member, the shaft being adapted to cooperate with a groove formed in the perimeter rail.

16. The engine as claimed in claim 13, wherein each drive member includes a guide shaft projecting from a free end part of the drive member, the shaft being adapted to cooperate with a groove formed in the perimeter rail.

17. The engine as claimed in claim 2, including a housing having a wall which delimits part of the cavity, the housing including an end mounted to pivot on the frame about an axis parallel to the longitudinal axis and being mobile between a position minimizing a volume of the intake compartment and a position maximizing the volume of the intake compartment.

18. The engine as claimed in claim 3, including a housing having a wall which delimits part of the cavity, the housing including an end mounted to pivot on the frame about an axis parallel to the longitudinal axis and being mobile between a position minimizing a volume of the intake compartment and a position maximizing the volume of the intake compartment.

19. The engine as claimed in claim 4, including a housing having a wall which delimits part of the cavity, the housing including an end mounted to pivot on the frame about an axis parallel to the longitudinal axis and being mobile between a position minimizing a volume of the intake compartment and a position maximizing the volume of the intake compartment.

20. The engine as claimed in claim 5, including a housing having a wall which delimits part of the cavity, the housing including an end mounted to pivot on the frame about an axis parallel to the longitudinal axis and being mobile between a position minimizing a volume of the intake compartment and a position maximizing the volume of the intake compartment.
